(19) United States
(12) Patent Application Publication
(10) Pub. No.: US 2018/0220865 A1
(43) Pub. Date: Aug. 9, 2018

(54) PUMP DEVICE FOR A WATER-CONDUCTING DOMESTIC APPLIANCE, METHOD FOR OPERATING SUCH A PUMP DEVICE, AND WATER-CONDUCTING DOMESTIC APPLIANCE

(71) Applicant: E.G.O. ELEKTRO-GERATEBAU GMBH, Oberderdingen (DE)

(72) Inventors: Uwe Schaumann, Oberderdingen (DE); Wolfgang Thimm, Karlsruhe (DE); Lutz Ose, Sternenfels (DE)

(21) Appl. No.: 15/878,645

(22) Filed: Jan. 24, 2018

(30) Foreign Application Priority Data
Feb. 9, 2017 (DE) 10 2017 202 062.8

(51) Int. Cl. A47L 15/42; F04B 43/12; F04B 43/00; F04B 23/02; F04B 53/08; D06F 17/02; D06F 39/00; D06F 39/08; C02F 1/68; C02F 5/08; C02F 1/32

(52) U.S. Cl. CPC A47L 15/4297; F04B 43/1215; F04B 43/0027; F04B 23/025; F04B 53/08; D06F 17/02; C02F 2103/002; D06F 39/085; C02F 1/685; C02F 5/08; C02F 1/32; A47L 2401/07; C02F 2303/04; D06F 39/004

(57) ABSTRACT

A pump device for a water-conducting domestic appliance, such as a washing machine or a dishwasher, has a pump chamber with at least two inlets, and has multiple actuators on or in the pump chamber for a liquid-pumping operation in at least one direction. At least one sensor is provided on or in the pump chamber for determining constituents and properties of the liquid in the pump chamber. A storage chamber is connected to an inlet of the pump chamber and contains additives or analytes for the liquid.

### FIELD OF APPLICATION AND PRIOR ART

The invention relates to a pump device for a water-conducting domestic appliance, such as for example a washing machine or a dishwasher, to a corresponding water-conducting domestic appliance, and to a method for operating such a pump device.

It is known from WO 02/077353 A1 that, during a washing procedure in a washing machine, additives can be added by means of a separate dosing device. An exact dosing of additives is problematic, however.

### PROBLEM AND SOLUTION

The invention is based on the problem of providing a pump device mentioned in the introduction, a domestic appliance equipped therewith and a method for operating such a pump device, with which problems of the prior art can be solved and with which it is possible in particular to provide a pump device which is able to be used and applied in a variety of ways or to make possible the use of additives and/or analytes during the operation of such a water-conducting domestic appliance. In particular, an exact dosing of additives and/or analytes shall be achieved.

Said problem is solved by a pump device having the features of claim 1, a method having the features of claim 17 and a corresponding water-conducting domestic appliance having the features of claim 22. Advantageous and preferred configurations of the invention form the subject matter of the further claims and are discussed in more detail below. In this case, some of the features are described only for the pump device, only for the method or only for the water-conducting domestic appliance. However, irrespective of that, they are intended to be able to apply separately and independently of one another not only to the pump device itself but also to a corresponding method and to a corresponding domestic appliance. The wording of the claims is incorporated in the content of the description by express reference.

It is provided that the pump device is precisely intended for a water-conducting appliance or domestic appliance, such as for example a washing machine or a dishwasher. However, it may also be advantageously used in other water-conducting appliances. The pump device has at least one pump chamber which has at least two inlets, wherein at least one inlet of the pump chamber may advantageously also have the function of an outlet. Advantageously, there is provided a single inlet which serves only as an inlet, while a plurality of inlets which may also be outlets may also be present. An “inlet” is thus substantially a connection of the pump chamber to the outside independent of the main flow direction.

At least one actuator is provided on or in the pump chamber in order to be able to pump liquid in at least one direction, preferably in both directions, by way of the pump device. This can therefore be into the pump chamber to an inlet, possibly then to a further inlet with the function of an outlet. A further direction is out again to the inlet. Yet a further direction is from some other inlet into the pump chamber.

At least one sensor is provided on or in the pump chamber in order to be able to determine constituents and/or properties of the liquid in the pump chamber. Such a sensor may in principle be designed in a variety of ways, in particular it may be designed to be able to detect specific constituents, preferably chemical constituents, or specific contaminants, for example biological or other contaminants. Advantageously, there may be multiple sensors, for example also a so-called sensor array. Furthermore, it is also possible for electrical properties of the liquid in the pump chamber to be determined.

The pump device has a storage chamber which is connected to an inlet of the pump chamber. The storage chamber can contain additives and/or analytes for the liquid, as have been mentioned before. Advantageously, precisely one inlet of the pump chamber is provided per storage chamber, and so for the case where multiple storage chambers are desired or required, multiple corresponding inlets are also to be provided in the pump chamber. Thus, in each case, precisely one single inlet is connected to precisely one single storage chamber.

Provided in this way is a pump device whose basic structure is not only able to be extended but is also able to be used in a variety of ways and may be of small and compact design. Said pump device may be used, and specifically adapted, in a multiplicity of water-conducting appliances. It is thus possible for a type of modular pump device to be constructed using various base components. In the pump chamber, it is possible, for example, for properties of the liquid which is currently being used in the domestic appliance as operating liquid, for example washing water or rinsing water, to be determined. An examination or determination can take place directly, advantageously by means of the aforementioned sensor. Further examination possibilities result from the fact that an analyte is fed from at least one storage chamber by means of the actuator or in some other manner into the pump chamber or is admixed with the liquid or operating liquid present in said pump chamber. It is thus possible, for example using specific markers, for contaminants in the form of organic contaminants or else bacterial loads of the liquid of the domestic appliance to be detected, for which detection the sensors are then precisely responsible, after said contaminants or loads are made visible by way of the additives and/or analytes. Since this is known in principle, it is not necessary to discuss it in further detail. A corresponding appliance which functions according to this principle is offered by the company Microlan in the Netherlands under the name “Bactcontrol”.

It is also possible for additives from a storage chamber to be mixed in liquid, which additives have been brought into the pump chamber for this purpose by the at least one actuator in order, there, firstly to be mixed with the low volume of liquid. By means of the at least one actuator, this mixed liquid is then brought out of the pump chamber to the inlet and back into the appliance in order that the additive can act there according to its intended use.

In a first fundamental configuration of the invention, the pump chamber may be of rigid design. The actuator may have for example a piston which is able to move therein, with the result that the pump device is designed as a piston pump. Alternatively, the actuator may have a rotor which rotates therein, with the result that the pump device is a rotor pump. Further fundamental possibilities for designing a pump with a pump chamber of rigid design are known to a person skilled in the art and do not need to be discussed in further detail here. Pump devices of said type are preferred especially for relatively large volumes of liquid which are to be pumped. Piston pumps, especially, also have the very great advantage that, with these, it is possible to have very precise dosing or determination of the pumped quantity of liquid in dependence on the piston stroke and the frequency of the pumping.

In a second fundamental configuration of the invention, the pump chamber is of elastic design, wherein the at least one actuator is advantageously arranged on the outside of the pump chamber. A pumping process is realized here by way of variation of the shape of the pump chamber, in particular in that pressing onto the pump chamber in a surface region which corresponds to, in particular is slightly larger than, the actuator, occurs. This results in corresponding narrowing or reduction of the cross section of the pump chamber. If multiple actuators of said type are arranged on the pump chamber, in particular next to one another or sequentially in one direction, a pumping operation can take place. This is also known as a so-called “peristaltic pump”. As a result, very small pump devices may be constructed if the focus is therefore on structural size and to a lesser degree on maximum pump volume or maximum accuracy. A further advantage is that the mechanical complexity is relatively low and the reliability is relatively high since no additional motors or drives are required as is the case for piston pumps or rotor pumps.

In such a pump device it may advantageously be provided that multiple similar, in particular identical, actuators are arranged on the outside of the pump chamber. Preferably, there are three actuators to six actuators or ten actuators. If the pump chamber is advantageously relatively flat and elongated, it is possible for the actuators to be arranged, preferably opposite one another, on the oppositely situated flat sides. Simultaneous actuation of two oppositely situated actuators allows the cross section, situated therebetween, of the pump chamber to be reduced or narrowed very well. Particularly advantageously, multiple, in particular up to ten, actuators are used on one or each side of the pump chamber.

During the operation of the pump device, it is possible for those actuators which are arranged closest to the inlets to be in the form of a closure device for the latter. Consequently, said actuators should be arranged on the pump chamber very close to the inlets and be designed to be able to narrow the cross section of the pump chamber to such an extent that at least one of the inlets, preferably all the inlets, is/are closed. Alternatively, it is also possible for separate valves to be provided.

Actuators, use is advantageously made of strip-shaped actuators which should be arranged in particular parallel to one another. They may have a length which is two times to eight times their width. Advantageously, their longitudinal extent is in a direction perpendicular to a direction of the pump chamber from one inlet to another inlet or perpendicular to the pumping direction.

In an advantageous configuration of the invention, actuators on the outer side of the elastic pump chamber are dielectric, electroactive polymers. When a current is applied, said actuators may contract or expand and, in the process, in each case narrow or reduce, or expand, the cross section of the pump chamber. Electroactive polymers of said type are generally known from actuator technology and sensor technology, as are the attachment and activation thereof.

The pump chamber itself may advantageously be a flat silicone tube for very good and long-lasting flexibility and also for a particular thermal resistance. The actuators may in this case be directly fastened on the tube by adhesive bonding or the like, or alternatively attached by mechanical fastening such as clamping or the like. In this respect, reference is substantially made specifically to known peristaltic pumps. It is also possible for an electroactive polymer material itself to consist of silicone film. ELASTOSIL® Film silicone film is a completely novel development of the company WACKER in Germany. Such a wafer-thin, high-precision film composed of crosslinked silicone rubber is available as roll goods in different layer thicknesses from 20 μm to 400 μm. It is produced under clean room conditions and completely without solvents. ELASTOSIL® silicone film is extremely highly suitable as a dielectric precision layer in innovative and pioneering electronics applications, which use so-called EAPs (electroactive polymers), for example as actuators, generators and smart sensors.

Advantageously, the pump device may further have heating means, in particular ohmic heating means or resistance heaters. Heating means of said type are advantageously arranged on an outer side of the pump chamber, in particular fastened on said outer side. They may, for example, be fastened on an outer side of the pump chamber in a manner alternating with aforementioned actuators. Since such heating means are normally designed such that they are relatively rigid and at least cannot vary in length, it is advantageously provided in the case of an elastic pump chamber that the heating means are pressed onto the pump chamber in a way similar to that described before as a possibility for the actuators. Possibly, flexible heating means or heating elements composed of textile fabrics with enwoven heating conductors may also be used. These may continue to bear against the pump chamber even during movement thereof and may have a good heating action. Also conceivable as heating conductors are carbon nanotube layers on the pump chamber. Corresponding heaters are offered by the company Future Carbon under the name “carbo-E-therm”.

In a further configuration of the invention, the pump device has a UV emitter, in particular a UV LED. Consequently, it is possible for liquid in the pump chamber to be treated, for example for microorganisms to be killed off. Furthermore, a UV emitter makes it possible to carry out some analyses better, for example if, as analyte, a particular UV marker has been added to liquid in the pump chamber. Thus, these same microorganisms can be made visible by means of the UV emitter after being marked. Furthermore, at least one corresponding UV detector may be provided, which then detects the very UV radiation which is reflected or is visible.

As one option, UV emitters and/or UV detectors may be arranged directly in the pump chamber, that is to say inside it. It is then the case that slightly greater effort is required with regard to the associated electrical connections and sealing. Alternatively, said emitters and detectors may be arranged outside the pump chamber and radiate into the pump chamber, or receive light from the pump chamber, by way of correspondingly light-transmissive regions or cutouts. This is possible by way of light-transmissive silicone tubes corresponding to the type mentioned in the introduction. The provision of multiple light sources which are completely different, or light sources with variable wavelengths, is also generally possible in order to be able to carry out different examinations.

One inlet of the pump device or the pump chamber is advantageously connected to a treatment space of a water-conducting appliance, or domestic appliance, according to the invention. In this case, a height difference between the treatment space or a water outlet there and the inlet or the pump chamber may be provided such that the water or the liquid flows automatically at least in one direction. Here, the pump device is advantageously not provided below the treatment space or a sump of the treatment space, and so the possibility always exists at any point in time during the operation of the device for liquid to be introduced from the treatment space into the pump device or to be pumped without taking in air. Alternatively, the pump device may be arranged above the treatment space or a sump thereof, in order that water pressure in the treatment space or at the sump does not automatically force water into the pump device. A return of the liquid can then be correspondingly simple. In an advantageous configuration of the invention, it is in this case possible for a ventilation means to be provided for the pump chamber, in particular by means of an actuable valve. This may be helpful especially during the return pumping. Alternatively, an inlet of the pump chamber may likewise be connected to the treatment space, so that liquid from the pump chamber does not have to take the same route back through the inlet again into the treatment space but passes back into the treatment space more or less by way of circulation by means of pumping. It is thus also possible to avoid the case in which water stands in a line between the treatment space and the inlet of the pump chamber for too long, which would in turn be unfavourable in many cases.

In yet a further configuration of a domestic appliance according to the invention, it is possible for said appliance to have at least two pump devices. These may in principle have the same design and are advantageously of identical design. This allows effort to be saved for different variants. This may be possible especially for numerous analysis purposes.

In a storage chamber which is connected to the pump chamber via an inlet, it is possible as one option for different analytes, mentioned before, to be provided. Alternatively, it is also possible for additives, for example intensive cleaners, bleaches, softeners, descalers, etc., to be contained for a process in the water-conducting domestic appliance.

Heating of the liquid in the pump chamber may serve for the analysis of said liquid, in particular in order to speed up specific chemical processes for the analysis. Furthermore, it is also possible for encapsulated substances to be thermally extracted or released from, for example aforementioned, additives. Said extraction or release can be promoted by way of a particular pressure during the pump movement, in particular if pumping according the peristaltic principle is involved.

It is also possible for substances such as enzymes or the like to be contained in a storage chamber, either in order to perform an analysis or else in order to assist with the treatment in the treatment space. In this respect, are also known measuring methods for determining the enzyme activity are also known, see for example EP 670367 A1.

A volume of the pump chamber may be relatively small, for example at most 1 cm³ to 5 cm³ or 10 cm³. The storage chambers may be larger, for example 5 cm³ to 500 cm³.

During the operation of the water-conducting domestic appliance, it is thus possible to pump liquid or water from the water-conducting domestic appliance into the pump chamber. During treatment carried out there, the liquid is analysed, for example according to one of the aforementioned possibilities. Various analytes and/or marker substances from a storage chamber, which is connected to the pump chamber, may serve this purpose. After the treatment or analysis, the liquid or the water is pumped back into the treatment space again and, there, is mixed again or put to further use.

In an alternative possibility of the invention, it can be provided that an additive from one of the connected storage chambers is admixed, by means of the actuator, with the liquid brought from the treatment space into the pump chamber. The liquid is then pumped back into the treatment space of the domestic appliance again or is pumped further along in the case of a circuit-like construction, and so here the emphasis is not so much on the properties of the liquid in the treatment space being important, but rather on for example an aforementioned additive such as a descaler, an intensive cleaner or the like being admixed. In this case, reasonably precise dosing may be carried out.

These and further features emerge not only from the claims but also from the description and the drawings, wherein the individual features can be realized in each case by themselves or as a plurality in the form of subcombinations in an embodiment of the invention and in other fields and can constitute advantageous and inherently protectable embodiments for which protection is claimed here. The subdivision of the application into individual sections and subheadings does not restrict the general validity of the statements made thereunder.

### BRIEF DESCRIPTION OF THE DRAWINGS

Exemplary embodiments of the invention are schematically illustrated in the drawings and will be discussed in more detail below. In the drawings:

FIG. 1 shows a highly schematic illustration of a water-conducting domestic appliance according to the invention as a washing machine with a pump device according to the invention,

FIG. 2 shows an enlargement of a plan view of the pump device according to the invention in a first configuration,

FIG. 3 shows the pump device from FIG. 2 in side view,

FIG. 4 shows the pump device from FIG. 3 with actuators, actuated in the central region, on the upper side and the lower side,

FIG. 5 shows a modification of an arrangement of a pump device according to the invention in a second configuration at a drum of the washing machine similar to FIG. 1, and

FIG. 6 shows a further modification of an arrangement of a pump device according to the invention in a third configuration with circulation at a drum of the washing machine similar to FIG. 1.

### DETAILED DESCRIPTION OF THE EXEMPLARY EMBODIMENTS

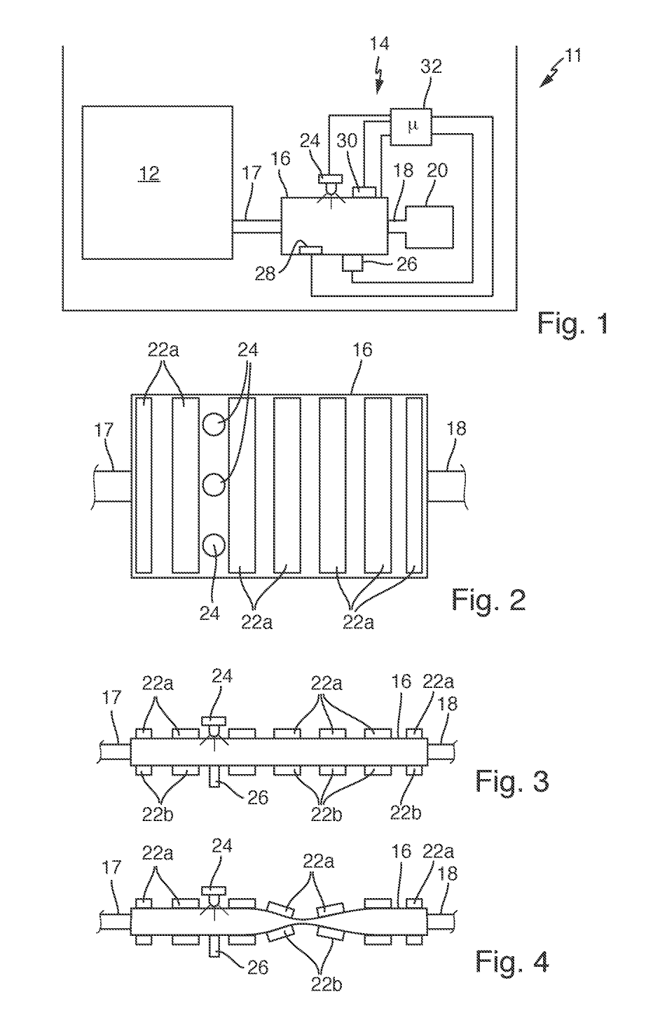

In FIG. 1, a washing machine 11, which has a drum 12 as a treatment space, is illustrated highly schematically as a water-conducting domestic appliance according to the invention. As has been discussed in the introduction, it would also be possible for a dishwasher, or some other water-conducting domestic appliance having at least one treatment chamber corresponding to the drum 12, to be provided instead of the washing machine 11.

In the arrangement in FIG. 1, a pump device 14 according to the invention according to a first configuration of the invention is provided. The pump device 14 has an elongated pump chamber 16 which is connected at one end on the left to the drum 12 in a water-conducting manner via a first inlet 17. A second inlet 18 is provided on the right or at the other end of the pump chamber 16, via which inlet the latter is connected to a storage chamber 20. The size of the storage chamber 20 in comparison with the pump chamber 16 is not illustrated to scale here, and the storage chamber 20 may be significantly larger.

Various function units are provided at the pump device 14 or at the pump chamber 16. A UV LED 24 which radiates into the pump chamber 16 is provided on the upper side. For this purpose, the pump chamber 16 is to be designed in a correspondingly light-transmissive manner at least in the region of the UV LED 24, either by way of the material selection for the pump chamber 16 itself or else by using a light-transmissive window or the like. One use of the UV LED 24 can be for performing a disinfection in the pump chamber 16, as has been discussed before. Advantageously, it is possible to provide said LED for a marking function with a marker from the storage chamber 20 for various contaminants and/or microorganisms in the liquid, for which a detector 26 is then arranged at the pump chamber 16. Said detector too is arranged at a light-transmissive region of the pump chamber 16, advantageously such that it is able to detect as well as possible when the UV LED 24 makes visible specific substances or microorganisms in the liquid in the pump chamber 16. However, this is known from the prior art and does not need to be discussed in more detail here.

Furthermore, a sensor 28 is provided in the pump chamber 16. In principle, said sensor 28 can be of any nature or have any function. In particular, it can detect specific constituents in the liquid in the pump chamber 16 and can therefore also be a relatively complex sensor, for example a biosensor.

A heating element 30 is illustrated on the upper side of the pump chamber 16 as an exemplary fitting location. Said heating element 30 may in principle be provided at any desired location, in particular also over a relatively large area, and multiple heating elements 30 may be provided. As has been discussed in the introduction, the heating element 30 serves for heating liquid in the pump chamber 16 in order in particular to allow or speed up specific reactions or processes.

Said function units of UV LED 24, detector 26, sensor 28 and heating element 30 are all connected to a controller 32. Said controller 32 is also connected to the pump chamber 16 itself such that it can correspondingly activate actuators, fitted to said chamber, for the purpose of pumping. Furthermore, the controller 32 activates the aforementioned function units or evaluates these.

It can be seen from the enlarged plan view of the pump chamber 16, as the central function part of the pump device 14, that, in this configuration of the invention, a peristaltic pump, described in the introduction, is present. For this purpose, the pump chamber 16 consists of an elastic material, for example designed as a flat silicone tube or as a flat and flexible rectangular housing. The inlets 17 and 18 run off at opposite ends and are advantageously formed integrally with the pump chamber 16. Connection to the drum 12 or to the storage chamber 20 can be realized via plug-in nipples, clamping nipples or the like.

In said peristaltic pump, arranged at the pump chamber 16 are multiple strip-shaped actuators 22a on the upper side and actuators 22b on an opposite lower side, as the comparison with FIGS. 3 and 4 also shows, wherein the upper side and the lower side are in each case flat sides. The actuators 22 may be adhesively bonded, cast in or connected in some other manner to the pump chamber 16, in particular fixedly connected thereto. It can be seen firstly that the surface or the longitudinal extent of the pump chamber 16 between the inlets 17 and 18 is covered relatively well by the in each case seven actuators 22a or 22b, respectively, with the result that a good pump effect can be assumed here. At the same time, there is still sufficient space between individual actuators 22 to arrange or to fasten the UV LED 24 on the outside such that they have a sufficiently large irradiation surface into the pump chamber 16. According to the side view of FIGS. 3 and 4, the detector 26 is arranged opposite the UV LED 24, with the result that said detector likewise has sufficient space for its arrangement between two actuators 22b.

The heating means 30, and likewise the sensor 28, are not illustrated here. However, on the basis of the statements made above, the arrangement thereof is easily conceivable for a person skilled in the art. As one option, electrical contacting to the sensor 28 towards the outside may lead through the wall of the pump chamber 16, wherein such a passage must then be well sealed. Alternatively, it is possible for an electrical connector, as a thin cable, to be led out to the inlet 17 or 18 and, there, to then run to the outside at a point which can be sealed more easily since said point may in particular consist of rigid material and does not have to be moved to as great an extent as the wall of the pump chamber 16 itself.

The comparison of FIGS. 3 and 4 shows how, by activating or actuating two central actuators 22a above and actuators 22b below, significant cross-sectional narrowing can be achieved, possibly even to the extent that the chamber walls make contact. This is not essential, however. By way of sequential activation and deactivation of actuators, situated next to one another, in the direction of the desired pumping direction, as known for peristaltic pumps, it is possible in the pump chamber 16 for liquid to be pumped. The different possibilities have already been mentioned before. On the one hand, it is possible for water or liquid to be pumped from the drum 12 into the pump chamber 16. On the other hand, the water can be pumped out again.

Those actuators 22a and 22b which are in each case on the extreme left and on the extreme right serve as a type of closure device for inlets 17 and 18 or as a type of valve. For said actuators, it should be provided, possibly by way of projections in the manner of ribs or the like provided on the inner side of the wall of the pump chamber 16, that the cross-sectional narrowing is indeed realized to the extent that the pump chamber walls make contact. A type of valve function with a closure effect for the inlets 17 and 18 can then be achieved, so that it is possible to forego separate valves or other closure devices. This especially allows in each case precise dosing of the pumped liquid or adding of additives or analytes, mentioned in the introduction, from the storage chamber 20.

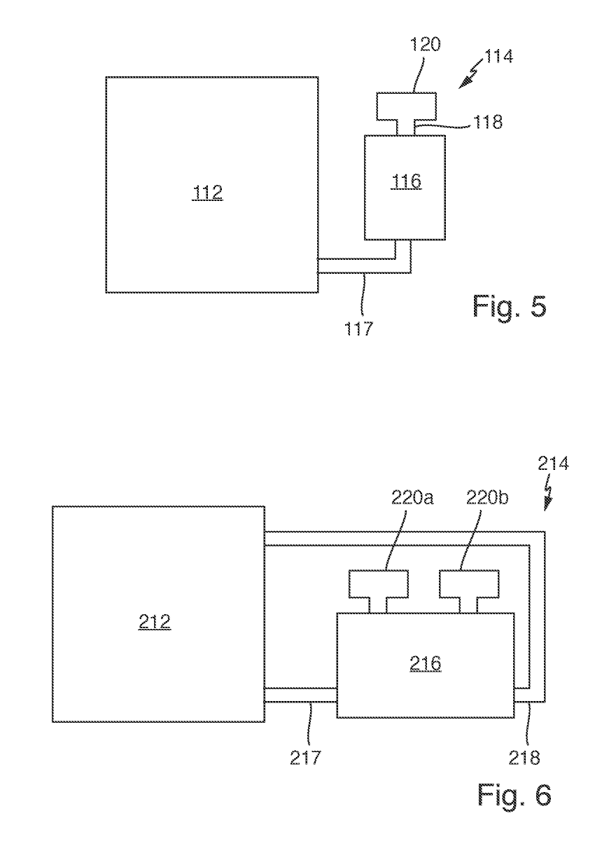

In principle, it is also possible for the other types of pumps discussed before, for example piston pumps or rotary pumps, to be used in a washing machine 11 corresponding to FIG. 1 with the respective water conduit. This applies also to the subsequent arrangements in FIGS. 5 and 6.

FIG. 5 illustrates a further pump device 114 in a second configuration corresponding to the invention, having a pump chamber 116 which can largely correspond to the pump chamber in FIGS. 1 to 4 and is therefore not discussed in further detail again. It is also a peristaltic pump. However, here the pump chamber 116 is designed such that it extends more or less vertically or its pumping direction is vertical. A water-conducting connection from the drum 112 as inlet 117 runs to a lower end of the pump chamber 116. At the upper end of the pump chamber 116, an inlet 118 to a storage chamber 120, which is arranged higher than or above said pump chamber, is provided. It can thus be achieved that, after opening a closure device described before, which more or less operates as a valve for the storage chamber 20 or the inlet 118, additives or analytes pass from the storage chamber 120 into the pump chamber 116 substantially automatically, that is to say under the action of gravity. In a similar manner, as a result of the arrangement of the pump chamber 116 above the inlet 117 as a connection to the drum 112, it can be achieved that liquid, assisted by the action of gravity, flows from the pump chamber 116 back into the drum 112.

Yet another, third configuration of an arrangement or pump device 214 according to the invention provides in FIG. 6 that a pump chamber 216 has a substantially arbitrary pumping direction, here horizontal from a first inlet 217 leading to a drum 212 through the pump chamber 216 towards a second inlet 218. However, said inlet 218 then leads directly back to the drum 212 again, and so here the pump device 214 operates in circulation, so to speak, or can circulate liquid. This can simplify an examination or treatment of the liquid in the pump chamber 216, in particular the reliable and complete return thereof into the drum 212 associated with reliable emptying of the pump chamber 216. Therefore, such an arrangement may especially be an advantage if additives are to be fed into the drum 212 by means of the pump device 214, for example for the purpose of assisting with a washing process. Here, the pump chamber 216 has two storage chambers 220a and 220b which are arranged or attached on the upper side. Said storage chambers are provided with separate actuators or closure devices or the like, with the result that additives can be fed from the storage chambers into the pump chamber 216 individually, said additives then being able to be fed into the drum 212 by way of liquid which is pumped along therewith. Furthermore, it may also be provided that additives for a washing process in the drum 212 are provided in the one storage chamber 220a. In the other storage chamber 220b, analytes may be provided for an analysis of the water from the drum 212. Consequently, such a pump device 214 allows water or liquid in the drum 212 to be both analysed and mixed with additives, depending on requirement.

1. Pump device for a water-conducting domestic appliance, such as a washing machine or a dishwasher, said pump device having:
a pump chamber with two inlets,
at least one actuator on or in said pump chamber for a liquid-pumping operation in at least one direction,
at least one sensor on or in said pump chamber for determining constituents and/or properties of said liquid in said pump chamber,
a storage chamber which is connected to an inlet of said pump chamber and which contains additives and/or analytes for said liquid.

2. Pump device according to claim 1, wherein said pump chamber is of rigid design, and said actuator has a piston being able to move therein, as a piston pump, or said actuator has a rotor which rotates therein, as a rotor pump.

3. Pump device according to claim 1, wherein said pump chamber is of elastic design, wherein arranged on an outside of said pump chamber is said at least one actuator for a pumping process by way of variation of a shape of said pump chamber.

4. Pump device according to claim 3, wherein said at least one actuator is adapted for said pumping process by way of pressing onto said pump chamber in a surface region which corresponds to said actuator with corresponding narrowing or reduction of a cross section of said pump chamber.

5. Pump device according to claim 3, wherein multiple similar of said actuators are arranged on said outside of said pump chamber.

6. Pump device according to claim 5, wherein said actuators are identical.

7. Pump device according to claim 5, wherein three said actuators to ten said actuators are arranged on said outside of said pump chamber.

8. Pump device according to claim 5, wherein said actuators are arranged next to one another in a direction from one inlet to another inlet of said pump chamber.

9. Pump device according to claim 3, wherein said actuators are of strip-shaped form and are arranged parallel to one another.

10. Pump device according to claim 9, wherein said actuators extend in a direction perpendicular to a direction from one inlet to another inlet of said pump chamber.

11. Pump device according to claim 3, wherein said actuators on said outer side of said elastic pump chamber are electroactive polymers.

12. Pump device according to claim 3, wherein said pump chamber is a silicone tube.

13. Pump device according to claim 3, wherein one said actuator is designed to close an inlet of one of the following chambers: said pump chamber and/or said storage chamber.

14. Pump device according to claim 1, wherein said device has ohmic heating means.

15. Pump device according to claim 14, wherein said heating means are arranged on an outer side of said pump chamber.

16. Pump device according to claim 1, wherein arranged on or in said pump chamber is at least one UV emitter and/or at least one UV detector.

17. Method for operating said pump device according to claim 1 in a water-conducting domestic appliance, with the steps of:
pumping said liquid or water from said water-conducting domestic appliance into said pump chamber,
subjecting said liquid or said water to treatment in said pump chamber,
finally pumping said liquid or said water back again into said water-conducting domestic appliance.

18. Method according to claim 17, wherein, as treatment in said pump chamber, said liquid in said pump chamber is mixed with an additive and/or with an analyte from said storage chamber by way of said at least one actuator, wherein said liquid is subsequently pumped back again said water-conducting domestic appliance.

19. Method according to claim 18, wherein said liquid is pumped back again into said water-conducting domestic appliance in order that said additive and/or said analyte from said storage chamber acts according to its/their intended use during operation of said water-conducting domestic appliance.

20. Method according to claim 17, wherein water or liquid is pumped from said water-conducting domestic appliance into said pump device and is examined there by means of said sensor.

21. Method according to claim 20, wherein, for the purpose of examination, heating means according to claim 14 are additionally used and/or an additive or an analyte is brought from said storage chamber into said pump chamber in order to assist with said examination.

22. Water-conducting domestic appliance having a pump device according to claim 1, wherein said water-conducting domestic appliance is a washing machine or a dishwasher and has a treatment space which is connected in a water-conducting manner to said pump device.

23. Water-conducting domestic appliance according to claim 22, wherein said pump device is arranged above a base or sump of said treatment space.

24. Water-conducting domestic appliance according to claim 22, wherein said appliance has at least two said pump devices.
